(19) United States
(12) Patent Application Publication
(10) Pub. No.: US 2025/0088593 A1
(43) Pub. Date: Mar. 13, 2025

(54) DIRECT VOICEMAIL CALL SERVICE

(71) Applicant: Orange, Issy-les-Moulineaux (FR)

(72) Inventors: Zhihong Guo, Beijing (CN); Shi Jiao, Beijing (CN)

(21) Appl. No.: 18/566,356

(22) PCT Filed: May 30, 2022
(86) PCT No.: PCT/IB2022/000308

§ 371 Date: Dec. 1, 2023

(30) Foreign Application Priority Data
Jun. 3, 2021 (WO) PCT/CN2021/098131

(51) Int. Cl. H04M 3/533; H04L 65/1045; H04L 65/1069

(52) U.S. Cl. CPC H04M 3/5335; H04L 65/1045; H04L 65/1069; H04M 2201/42

(57) ABSTRACT

Methods, systems, computer programs, and computer-readable media to provide users with a direct-call-to-voicemail service are described. A direct-call-to-voicemail system includes a caller's user equipment, a proxy server, and a voicemail server for recording voice messages for a callee. The caller's user equipment sends the proxy server a call set-up request comprising information indicating a request by the caller to record a voicemail directly on the voicemail server serving the callee. The proxy server, responsive to discriminating the information indicating a request for direct recording of a voice message, retrieves callee status information, and, responsive to discriminating direct-voicemail authorization data in the retrieved callee status information, sets up a communication session between the caller's user equipment and the voicemail server, to enable recording of the voice message.

The present invention relates to the field of telecommunications. More particularly, the invention relates to methods, systems, computer programs, and computer-readable media to provide users with a direct-call-to-voicemail service.

Nowadays there are many software applications on mobile phones, tablets, and other computing devices that allow users to compose voice messages and send them to a chosen recipient. However, it is not always desired, or possible, to make use of such messaging applications: for instance, some people do not have such messaging applications on their devices, notably if their devices are older and do not employ the most recent generations of communications technology.

A user wishing to send a voice message to an intended recipient without use of a messaging application may be obliged to place a voice call to the recipient, even though they have no need to participate in a live conversation with that person.

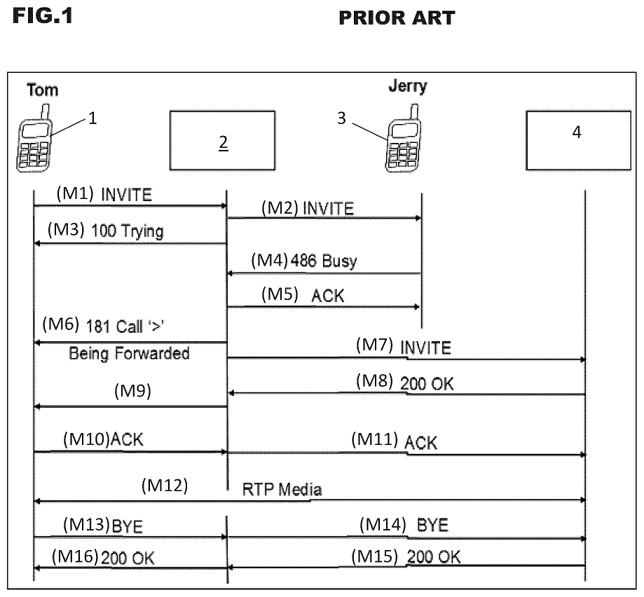

FIG. 1 illustrates messages that transit over communications networks in an example of a case where a user, Tom, wishing to send a voice message to a callee, Jerry, places a voice call to Jerry. In this example Jerry's telephone is busy and Tom is able to leave a voice message for Jerry on a voicemail server 4 that is associated with Jerry's network operator and user equipment.

The example illustrated in FIG. 1 relates to a case in which the signalling protocol used in the attempt to set-up the voice call is the session initiation protocol (SIP). In this example, the system includes a number of networked devices including a proxy server (SIP server 2) as well as the voicemail server 4 that is responsible for recording voicemail messages directed to Jerry, and the user equipment of Tom and Jerry (which is represented in the figure as a mobile phone 1 for Tom and a mobile phone 3 for Jerry). In a real-world implementation, in the attempt to set-up the voice call other equipment besides that represented in FIG. 1 may be involved, for instance, elements of the radio access network, gateways, servers/registers providing location services, etc., but such elements are not pertinent to the explanation here and so are not represented in the figure or discussed below.

FIG. 1 is based on the assumption that the mobile phones 1, 3 of Tom and Jerry are both already registered with the proxy server 2. However, the skilled person will readily understand the additional messaging, equipment and location services that may be employed in a case where the callee's user equipment 3 is not connected to the same SIP proxy server as the caller's user equipment 1.

According to the example illustrated in FIG. 1, when Tom seeks to place a voice call to Jerry, Tom's mobile phone 1 generates a SIP request M1 of type “INVITE” including data identifying Jerry as the callee, and sends this message M1 to the proxy server 2 via a communications network (notably, a mobile communications network or the like). Although not pertinent to the present discussion, the SIP INVITE request includes the other usual headers and data, notably a session description in session description protocol (SDP). The proxy server 2 in its turn generates a SIP request M2 of type “INVITE” and sends this message M2 to Jerry's user equipment 3. The proxy server 2 also generates a SIP message M3 including a code 100 indicating that the proxy server 2 is trying to set up the call (i.e., is calling Jerry's mobile phone) and sends this message M3 to Tom's user equipment 1.

In the example illustrated in FIG. 1, Jerry's user equipment 3 is already on a call and so generates a SIP message M4 including a code 486 indicating that Jerry's user equipment is busy, and sends this message M4 to the proxy server 2. The proxy server 2 generates a SIP acknowledgement message M5 (i.e., a SIP message of type ACK) and sends this message M5 to Jerry's user equipment 3. The proxy server 2 also generates a SIP message M6 including a code 181 indicating that the proxy server 2 is forwarding the call (i.e., connecting Tom to the voicemail server 4 that serves Jerry's user equipment 3).

Based on Jerry's telephone number (which is identified from the data contained in Tom's initial message M1), the proxy server 2 determines the address of the voicemail server 4 applicable to Jerry's user equipment. Typically, the proxy server 2 makes this determination using a database (not shown) which may be stored on proxy server 2 or provided at another location (e.g., in another server). The proxy server 2 then generates a SIP request M7 of type “INVITE” and sends this message M7 to the determined voicemail server 4. The voicemail server 4 generates a SIP message M8 including a code 200 (OK) indicating that the voicemail server 4 is prepared to participate in an upcoming communication session and sends this message M8 to the proxy server 2. The proxy server 2 sends a comparable SIP OK message M9 to Tom's user equipment 1. Tom's user equipment 1 generates an acknowledgment SIP message M10 and sends message M10 to the proxy server 2. The proxy server 2 generates a corresponding acknowledgment message M11 and sends message M11 to the voicemail server 4. The voicemail server 20 and Tom's user equipment 5 now have all the information required in order to be able to establish a communication session with one another so that a voicemail message from Tom can be recorded by the voicemail server 4, for future playback by Jerry. This communication session is indicated in FIG. 1 by symbol M12 which, thus, designates a set of messages. Typically, the communication session designated by M12, between voicemail server 4 and Tom's user equipment 1, is performed according to the real-time transport protocol (RTP).

When Tom wishes to disconnect from the voicemail server 4, e.g., after recording a voicemail intended for Jerry, Tom's user equipment 1 ends the communication session by generating a SIP message M13 of type BYE, and sends message M13 to proxy server 2. Proxy server 2 sends a corresponding BYE message M14 to the voicemail server 4. The voicemail server 4 responds by generating a SIP message M15 including a code 200 (OK) indicating that the SIP request in message M13 has been successful, and sends this message M15 to the proxy server 2. The proxy server 2 sends a comparable SIP OK message M16 to Tom's user equipment 1, bringing the call to an end.

It can be seen from FIG. 1 that even in a case where the caller (Tom) has no interest in having a live conversation with the callee (Jerry), the call set-up process nevertheless includes several operations additional to those which procure the voice message and achieve recording of the message by the voicemail server 4 serving Jerry's user equipment 3. Thus, for instance, the proxy server 2 uses processing power to generate and transmit messages M2, M3 and M5, and Jerry's user equipment 3 uses processing power to generate and transmit message M4. These processes are redundant in a context where Tom merely wishes to communicate a voice message to Jerry, and waste processing power in proxy server 2 and in user equipment 3, as well as taking up time to no useful purpose. Moreover, the conveying of messages M2-M5 over communications networks increases network traffic to no advantage. Furthermore, additional redundant processes may be involved in a case where Tom and Jerry's devices are connected to different SIP domains.

Moreover, in a case where a caller sends a call set-up request in a context where, in reality, they only wish to record a voicemail, there is a significant risk that the callee may answer the call and this may involve the caller in wasting time additional to that required for transmission of the message content of the intended voicemail.

The present invention has been made in the light of these issues.

Embodiments of the present invention provide methods, systems, computer programs and computer-readable media that provide a direct-voicemail call service enabling callers to record a voice message directly at the voicemail server of a callee without a calling signal first being sent to the user equipment of the callee.

The present invention provides a computer-implemented method to record a direct voicemail message, typically implemented by a proxy server. This method comprises:
receiving, from a caller's user equipment, a call set-up request comprising information indicating a request by the caller to record a voice message directly on a voicemail server serving a callee;
discriminating, in the received call set-up request, said information indicating a request for direct recording of a voice message; and
responsive to discriminating, in the received call set-up request, said information indicating a request for direct recording of a voice message, retrieving callee status information;
discriminating direct-voicemail authorization data in the retrieved callee status information;
responsive to discriminating direct-voicemail authorization data in the retrieved callee status information, setting up a communication session, between the caller's user equipment and said voicemail server serving the callee, to enable recording of said voice message.

By this method, the proxy server can detect, in a call set-up request, information indicating the caller's desire to make a direct recording of a voice message and can establish accordingly a communication session between the caller's user equipment and the appropriate voicemail server, without first transmitting a call signal to the callee's user equipment, but still in a way that can be controlled by this callee. Accordingly, the caller can achieve direct recording of a voice message while avoiding redundant operations in the proxy server and callee user equipment, thereby achieving time savings and reducing processing in the proxy server and callee user equipment, while callees can exercise some control over direct recording of voice messages intended for them, notably by configuring callee status information to indicate whether or not direct recording of voice messages is authorized.

In an embodiment, this method further comprises:
if the discriminating of direct-voicemail authorization data determines that the callee does not authorize direct recording of voice messages, generating a call set-up request and sending the call set-up request to the callee's user equipment; and
if the discriminating of direct-voicemail authorization data determines that the callee authorizes direct recording of voicemails, determining which voicemail server is the voicemail server serving the callee and setting up said communication session, between the caller's user equipment and said voicemail server serving the callee, to enable recording of said voicemail.

In certain of the latter embodiments of the invention, the callee may configure direct-voicemail authorization data to indicate that direct-recording of voice messages is authorized conditionally dependent on the caller identity. In such embodiments, the method further comprises, if the discriminating of direct-voicemail authorization data determines that the callee authorizes direct recording of voice messages conditionally dependent on the caller identity, determining the identity of the caller and:
if the determined caller is not authorized by the callee to directly record voicemails, generating a call set-up request and sending the call set-up request to the callee's user equipment;
if the determined caller is authorized by the callee to directly record voicemails, determining which voicemail server is the voicemail server serving the callee and setting up said communication session, between the caller's user equipment and said voicemail server serving the callee, to enable recording of said voicemail.

In another embodiment wherein the call-set up request further comprises data identifying the callee, the method further comprises:
discriminating, in the received call set-up request, said data identifying the callee; and
responsive to discriminating, in the received call set-up request, said data identifying the callee, determining which voicemail server is said voicemail server serving the callee.

In certain embodiments of the above-mentioned server-implemented method, the proxy server is a Session Initiation Protocol (SIP) server, and the call set-up request is a SIP INVITE message. SIP servers are widely deployed and can readily be adjusted to implement the direct voicemail call service provided by the present invention, for example by a software update. Thus, deployment of a direct voicemail service can be achieved easily using SIP proxy servers.

In certain of these latter embodiments of the above-mentioned server-implemented method, the discriminating, in the received call set-up request, of the information indicating a request for direct recording of a voice message comprises analysis of header fields in the received SIP INVITE message. Existing header fields defined by the SIP specification can be adapted to carry data (e.g., a specific code) indicating that the SIP INVITE message is a request for direct recording of a voicemail on a voicemail server (i.e., the voicemail server serving a particular callee also identified in the SIP INVITE message). Other embodiments involve an extension of the SIP specification to include a new header field dedicated to direct voicemail recording, notably a dedicated header field taking one of two values, the first value (e.g., “YES”, a binary value 1, etc.) indicating that direct recording of a voicemail is requested in the current SIP INVITE message and the second value (e.g. “NO”, a binary value 0, etc.) indicating that direct recording of a voicemail is not requested in the current SIP INVITE message.

The present invention yet further provides a direct-voicemail system comprising:
a caller's user equipment;
a proxy server; and
a voicemail server for recording voice messages for a callee;
characterized in that:
the caller's user equipment is configured to send the proxy server a call set-up request comprising information indicating a request by the caller to record a voice message directly on said voicemail server serving the callee; and
the proxy server is configured to discriminate, in the received call set-up request, said information indicating a request for direct recording of a voicemail, and, responsive to discriminating said information indicating a request for direct recording of a voicemail:
   to retrieve callee status information;
   discriminate direct-voicemail authorization data in the retrieved callee status information; and
   responsive to discriminating direct-voicemail authorization data in the retrieved callee status information, to set up a communication session, between the caller's user equipment and said voicemail server serving the callee, to enable recording of said voicemail.

The present invention still further provides a proxy server configured to enable direct recording of voicemail messages, the proxy server comprising:
a communications interface; and
a processor;
wherein the processor is configured:
   to discriminate, in a call set-up request received from a caller via the communications interface, information indicating a request for direct recording of a voice message; and
   responsive to discriminating said information indicating a request for direct recording of a voice message, retrieve callee status information;
   to discriminate direct-voicemail authorization data in the retrieved callee status information; and
   responsive to discriminating direct-voicemail authorization data in the retrieved callee status information, to set up a communication session, between the caller's user equipment and a voicemail server serving the callee, to enable recording of said voicemail.

In an embodiment, this proxy server is further configured, responsive to discriminating authorization data in the retrieved callee status information, to discriminate which voicemail server is the server serving the callee.

The present invention further provides a user equipment to enable direct recording of a voice message for a callee, the user equipment comprising a processing unit (50) configured to:
generate a call set-up request comprising information indicating a request to record a voice message directly on a voicemail server serving the callee; and
send said call set-up request to a proxy server in order to trigger, depending on direct-voicemail authorization data discriminated within callee status information retrieved by said proxy server, the setup of a communication session between the user equipment and a voicemail server serving the callee, to enable recording of said voice message.

In an advantageous embodiment, the user equipment further comprises a dialler application configured to present the caller with an input element enabling the caller to indicate a desire to record a voice message for a callee directly on a voicemail server serving said callee and, responsive to caller activation of said input element, trigger the generation by said processing unit of said call set-up request including information indicating a request to record a voice message directly on a voicemail serving the callee.

The present invention further comprises a computer-implemented method to enable direct recording of a voicemail message for a callee, the method being implemented by a caller's user equipment, the method comprising:
generating a call set-up request including information indicating a request for direct recording of a voice message, and
sending send call set-up request to a proxy server in order to trigger, depending on direct-voicemail authorization data discriminated within callee status information retrieved by said proxy server, the setup of a communication session between the user equipment and a voicemail server (14) serving the callee, to enable recording of said voice message.

The present invention still further provides a computer program comprising instructions which, when the program is executed by a processor of a caller's user equipment, cause the processor to implement the latter method.

The present invention still further provides a computer-readable medium comprising instructions which, when executed by a processor of a caller's user equipment, cause the processor to implement the latter method.

Further features and advantages of embodiments of the present invention will become apparent from the following description of said embodiments, which is given by way of illustration and not limitation, illustrated by the accompanying drawings, in which:

FIG. 1 is a diagram illustrating an example of messages exchanged between user equipment and servers in a case where a caller tries to set up a voice call to a callee and leaves a voice message on a voicemail server serving the callee's user equipment;

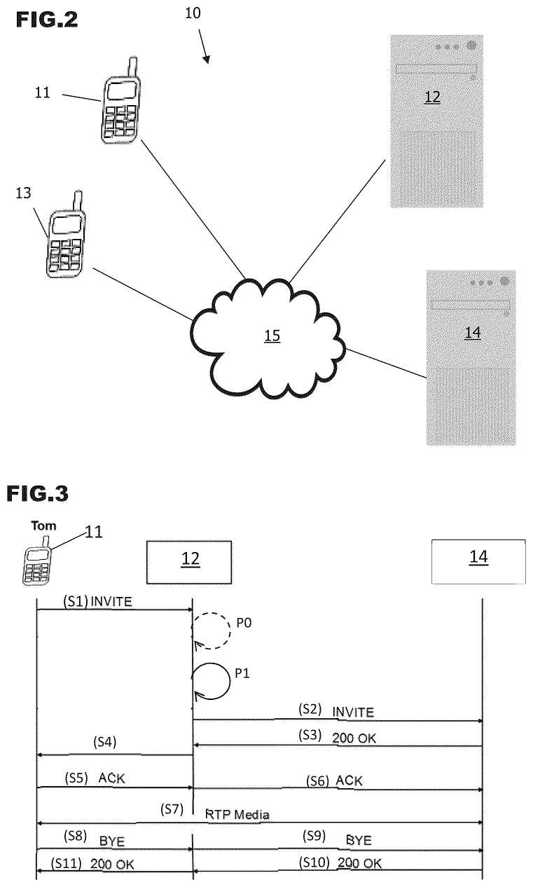

FIG. 2 is a diagram illustrating an example of a system according to an embodiment of the present invention;

FIG. 3 is a diagram illustrating an example of messages exchanged between user equipment and servers in a case where a caller makes a direct voicemail call using methods and devices according to an embodiment of the invention;

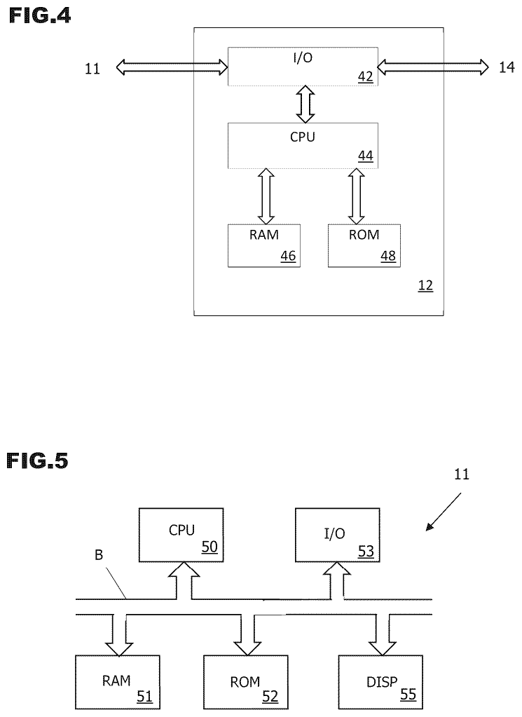

FIG. 4 is a block diagram illustrating a proxy server according to an embodiment of the invention;

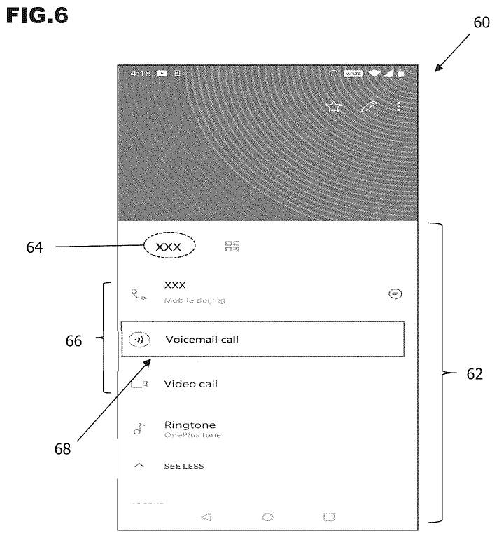

FIG. 5 is a block diagram illustrating an example of user equipment according to an embodiment of the invention; and

FIG. 6 represents an example of a screen display on a user equipment according to an embodiment of the invention.

Various features and principles of embodiments of the present invention will be described below.

FIG. 2 illustrates an example of a system 10 according to one embodiment of the present invention. According to the example illustrated in FIG. 2 the system 10 includes a server 12, such as a proxy server (e.g., a SIP proxy server); as well as the voicemail server 14 that is responsible for recording voicemail messages directed to Jerry, and Tom's user equipment 11 (which is represented in the figure as a mobile phone 11). The devices 11-14 in the system communicate via a communications network 15 which may comprise wired and/or wireless communications networks (e.g., mobile networks of different generations—2G, 3G, 4G, 5G, etc.).

As for FIG. 1, elements of the radio access network, gateways, etc., which are not germane to the explanation of the present invention are not represented in FIG. 2 and are not discussed here. Although Jerry's user equipment 13 is represented in FIG. 2 (as a mobile phone), Jerry's user equipment 13 is not involved in the direct recording of the voicemails directed to Jerry. Of course, Jerry may employ user equipment 13 to listen to recorded voicemails.

FIG. 3 illustrates an example of a sequence of messages that may transit over communications networks in an example of a system 10 according to the embodiment of FIG. 2 in the case where a user, Tom, seeks to obtain direct recording of a voicemail intended for callee, Jerry. Here “direct recording” of a voicemail refers to recording of a voicemail for Jerry on the voicemail server 14 that is associated with Jerry's network operator and user equipment without transmission to Jerry's user equipment 13 of a call set-up request.

The example illustrated in FIG. 3 relates to a case in which the signalling protocol used is the Session Initiation Protocol (SIP). As for FIG. 1, FIG. 3 is based on the assumption that the mobile phones 11, 13 of Tom and Jerry are both already registered with the proxy server 12. Once again, the skilled person will readily understand the additional messaging and equipment that may be employed in a case where the callee's user equipment 13 is not connected to the same SIP proxy server as the caller's user equipment 11.

According to the example illustrated in FIG. 3, when Tom seeks to make a direct recording of a voice message for Jerry, Tom's mobile phone 11 generates a SIP request S1 of type “INVITE” including information indicating that Tom is making a request for direct recording of the voice message intended for Jerry. The form of this information will be discussed below. Typically, the SIP INVITE request S1 also includes data identifying Jerry as the callee, for instance Jerry's telephone number/URI, etc. Tom's mobile phone 11 sends this message S1 to the proxy server 12 via communications network 15. The proxy server 12 discriminates in the SIP request S1 the information indicating that Tom is making a request for direct recording of the voice message intended for Jerry and, in response to determining that Tom is making a request for direct recording of a voice message: (a) performs a process P1 to determine which voicemail server is the one responsible for storing voicemails intended for Jerry, and (b) sets up a communication session between Tom's user equipment 11 and the determined voicemail server (in this case voicemail server 14).

The proxy server 12 may determine the address of the callee's voicemail server using callee address information contained in the SIP INVITE request S1 (e.g., the callee's telephone number/URI, etc.) using known techniques, notably those usually employed in a case where a SIP proxy server is informed that a callee is not taking a call, i.e., by look-up in a database that may be included in the proxy SIP server or in another server. The database lists the voicemail server address associated with the callee's address information and provides the proxy server 12 with the address to the appropriate voicemail proxy server 14. The database may also provide the proxy server 12 with the callee's SIP account address.

The setting up of the communication session between Tom's user equipment 11 and the voicemail server 14 involves a sequence of operations S2-S6 discussed below.

The proxy server 12 generates a SIP request S2 of type “INVITE” and sends this message S2 to the voicemail server 14 whose address was determined in process P1. The SIP INVITE request S2 may also include the callee's SIP account address. The voicemail server 14 generates a SIP message S3 including a code 200 (OK) indicating that the voicemail server 14 is prepared to participate in an upcoming communication session and sends this message S3 to the proxy server 12. The proxy server 12 sends a comparable SIP OK message S4 to Tom's user equipment 11. Tom's user equipment 11 generates an acknowledgment SIP message S5 and sends message S5 to the proxy server 12. The proxy server 12 generates a corresponding acknowledgment message S6 and sends message S6 to the voicemail server 14. The voicemail server 14 and Tom's user equipment 11 now have all the information required in order to be able to establish a communication session with one another so that a voice message from Tom can be recorded by the voicemail server 14, for future playback by Jerry. This communication session is indicated in FIG. 3 by symbol S7 which, in this instance, designates a set of exchanged messages. Typically, the communication session designated by S7, between voicemail server 14 and Tom's user equipment 11, is performed according to the real-time transport protocol (RTP).

When Tom wishes to disconnect from the voicemail server 14, e.g., after recording a voicemail intended for Jerry, Tom's user equipment 11 ends the communication session by generating a SIP message S8 of type BYE, and sends message S8 to proxy server 12. Proxy server 12 sends a corresponding BYE message S9 to the voicemail server 14. The voicemail server 14 responds by generating a SIP message S10 including a code 200 (OK) indicating that the SIP request in message S9 has been successful, and sends this message S10 to the proxy server 12. The proxy server 12 sends a comparable SIP OK message S11 to Tom's user equipment 11, bringing the call to an end.

It can be seen from FIG. 3 that according to this embodiment of the invention the caller (Tom) has been able to record a voice message directly on the callee's voicemail server, without the need for a call message to be transmitted to Jerry's user equipment 13 beforehand. Thus, redundant processes are avoided (such as generation and transmission of messages M2-M5 of FIG. 1), saving time and processing power, as well as reducing traffic on the communications network. More specifically, compared to the call flow illustrated in FIG. 1, the method according to the embodiment of the invention illustrated in FIG. 3 avoids all the signalling between the proxy server and the callee's user equipment, hence saving signalling resources in the network as well as being more time efficient.

In a variant of the embodiment described above, the callee has the facility to activate or deactivate the direct voicemail call service in respect of voice messages directed to them. More particularly, the callee is provided with the opportunity to configure and store direct-voicemail authorization data, and the proxy server 12 is configured to consult the stored direct-voicemail authorization data (P0 in FIG. 3) upon receipt of a SIP INVITE request (e.g., message S1 in FIG. 3) containing information indicating that the caller wishes to record a voice message directly on the callee's voicemail server. If the proxy server 12 determines from the direct-voicemail authorization data that the callee does not authorize direct recording of voice messages, the SIP server 12 responds by generating a voice-call request and sending the voice-call request to the callee's user equipment 13. On the other hand, if the proxy server 12 determines from the direct-voicemail authorization data that the callee authorizes direct recording of voice messages, the SIP server 12 responds by determining which voicemail server is the voicemail server 14 serving the callee and then setting up the communication session, between the caller's user equipment 11 and the voicemail server 14 serving the callee, to enable recording of the voicemail.

In existing commercial telecommunications systems, the service status (also designated as status information) of users is saved in a database. More particularly, in systems implementing the SIP protocol a respective SIP service profile may be stored for each registered user (including the callee). So, in certain implementations of the above-described variant embodiment, the users' status information such as the users' SIP service profile is enriched with information about the user's authorization of such a “direct call to voicemail” service. In such implementations, the proxy server 12 may be configured, upon receipt of a SIP INVITE request (e.g., message S1 in FIG. 3) containing information indicating that the caller wishes to record a voice message directly on the callee's voicemail server, to consult the direct-voicemail authorization data in the callee's status information (e.g. the callee's SIP service profile) to determine whether or not to set up the direct call to voicemail.

In a more sophisticated embodiment, the callee's service status may contain a list of callers' phone number for which this “direct voicemail” service is activated and/or a list of caller's phone numbers for which this service is deactivated, so that the proxy server 12 may check if the caller's phone number (which, in this case, is also inserted in the SIP INVITE request S1 sent to the proxy server 12) belongs to one of these lists and decides accordingly whether to direct the request to the callee's phone or directly to their voicemail server 14. Of course, identifiers other than phone numbers can be used for access control to the direct voicemail service.

FIG. 4 is a block diagram illustrating a proxy server 12 according to an embodiment of the invention. In the example illustrated in FIG. 4, the proxy server 12 comprises a communications interface 42, a processor 44, working memory 46 (e.g., RAM), and longer-term storage 48 (e.g., ROM storage). The skilled person will readily understand that other components may be present but, as they are not germane to the exposition of the invention, they are not discussed here.

In the example illustrated in FIG. 4, the processor 44 is configured to parse call set-up requests received via the communications interface 42. In particular, the processor 44 is configured to discriminate, in a received call set-up request, information indicating a request for direct recording of a voice message. The processor 44 is configured, responsive to detecting information indicating a request for direct recording of a voice message, to determine which voicemail server is the voicemail server 14 serving the callee, e.g., by database lookup as discussed above. The processor 44 may be configured, responsive to detecting information indicating a request for direct recording of a voice message, to first determine whether a direct call to voicemail is authorized by the callee (at all, or for this specific caller) before proceeding to make a determination as to which voicemail server is the voicemail server 14 serving the callee. The processor 44 is further configured, in the event that a direct call to voicemail is permitted, to set up a communication session, between the caller's user equipment 11 and the determined voicemail server 14 serving the callee, to enable direct recording of the desired voice message.

Typically, the appropriate “configuring” of the processor 44 involves programming of the processor 44 to implement a computer program containing instructions to implement a method comprising:
discriminating, in the received call set-up request, information indicating a request for direct recording of a voice message; and
responsive to discriminating, in the received call set-up request, the information indicating a request for direct recording of a voice message, setting up a communication session, between the caller's user equipment and said voicemail server serving the callee, to enable recording of said voice message.

Typically, the call-set up request further comprises data identifying the callee, and the programming of the processor 44 may be such that the method further comprises:
discriminating, in the received call set-up request, the data identifying the callee; and
responsive to discriminating, in the received call set-up request, said data identifying the callee, determining which voicemail server is the voicemail server serving the callee.

Such a computer program may be loaded in storage 48. Such a computer program may be provided on a computer-readable medium (disc, tape, etc.) accessed/read by the proxy server 12.

FIG. 5 is a block diagram illustrating an example of caller user equipment 11 according to an embodiment of the invention. The skilled person will readily understand that components additional to those described below may also be present in the caller user equipment 11, e.g., a gyroscope, a power management module, a camera, etc, but such components are not germane to description of the invention and so are not represented or discussed here.

The user equipment 11 enables direct recording of voice messages for a callee and comprises a processing unit 50 configured to:
generate a call set-up request comprising information indicating a request to record a voice message directly on a voicemail server serving the callee; and
send the call set-up request to a proxy server 12, in order to trigger the setup of a communication session, between the user equipment 11 and a voicemail server 14 serving the callee, to enable recording of said voice message.

In the example illustrated in FIG. 5, the caller user equipment 11 is a mobile phone comprising a central processing unit 50, a random-access memory 51 for holding intermediate computing results, a read-only memory 52 which stores instructions including those necessary to perform the method steps described below, an input/output interface 53 (comprising elements, such as keys and buttons, for receiving user input and comprising a communications interface for communication with devices, such as proxy server 12, via the communications network 15), and a display 55. These components may be interconnected by a system bus B. In many embodiments the display 55 is a touch-screen to display a graphical user interface (GUI) and to accept user input in relation to graphical elements displayed in the GUI; in such cases the display 55 may be considered to be part of the input/output interface 53.

In the example illustrated in FIG. 5, a SIP user agent client, and a dialler application, are installed on the caller user equipment 11 (e.g., these programs may be stored in the ROM 52 and may be activated in response to user input). The dialler application may be configured to present the caller with an input element enabling the caller to indicate a desire to record a voice message for a callee directly on a voicemail server serving user equipment of the callee. Further, the dialler application may be configured, responsive to caller activation of the input element, to instruct the processing unit 50 to generate a call set-up request including information indicating a request for direct recording of a voice message and to transmit the direct-call-to-voicemail request to proxy server 12 via the input/output interface 53.

Such a dialler application is an example of a computer program comprising instructions which, when the program is executed by a processor of a caller's user equipment, cause the processing unit of this user equipment:
to generate a call set-up request including information indicating a request for direct recording of a voice message, and
send the call set-up request to a proxy server 12, in order to trigger the setup of a communication session, between the user equipment 11 and a voicemail server 14 serving the callee, to enable recording of said voice message.

Such a computer program may be loaded in storage 52. Such a computer program may be provided on a computer-readable medium (disc, tape, etc.) accessed/read by the user equipment 11.

FIG. 6 represents an example of a screen image 60 that may be generated on a display 55 of a caller's user equipment 11 by the above-described dialler application. In the example illustrated in FIG. 6, the dialler application has generated a graphical image 62 in the GUI displayed on the display 55, in response to user input indicating a desire to call a callee XXX. The image generated by the dialler application includes data 64 identifying the selected callee XXX as well as a list 66 of types of call that the caller may choose from in order to place to a call to callee XXX. In this example the dialler application has generated an input element 68 (a new, selectable button image) which the user can activate in order to launch a direct-call-to-voicemail in accordance with the embodiments of the invention discussed above. For convenience, this new button may be placed near the dialing contact button. The user may click this button to dial into the contact's voicemail directly and click again to hang up the call after leaving a voice message.

From the network signalling point of view, when a user wants to leave a voice message in the voicemail of another user, the caller can click the voicemail button on the contact page in the dialer application. The dialer application then prepares a request (e.g., a SIP call INVITE request) and sends it to a SIP (proxy) server based on the callee's phone number (i.e., the request includes the callee's phone number as for a traditional call). In this call set-up request, the dialler application adds a specific indicator so that the SIP server 12 can determine, from this indicator, that this is a request to be transferred directly to the callee's voicemail, instead of being sent to the callee's phone as in the traditional way.

The specific indicator which the dialler application includes in the call set-up request can take various forms, for instance “X-preference: directly_voicemail” in a header field of the call set-up request, so that the proxy server can determine through this field that this is a request to be transferred directly to the voicemail. This header field can be a dedicated header field, specifically designed for indicating whether a direct call to the voicemail is requested (the specific indicator value then may just take the form of one of a pair of alternatives, e.g., “YES” or “NO”, “1” or “0”, etc.). Alternatively, the header field can be an already existing header field as defined in the applicable signaling standard, where a new indicator, specifically designed to indicate that a direct call to the callee's voicemail server is requested, is inserted, which is advantageous in that it allows reuse of the current standards.

Although the invention has been described above with reference to certain specific embodiments, it is to be understood that various modifications and adaptations may be made within the scope of the appended claims.

Thus, for example, although the embodiments described above relate to examples in which the call set-up signalling uses the Session Initiation Protocol, the invention may be applied in systems where other signalling systems are employed for call set-up, e.g., SS7 signalling.

### SPECIFIC EMBODIMENTS OF THE INVENTION

Various further aspects and features of, or related to, the present invention are set out in the following numbered clauses.
1. A computer-implemented method to directly record a voicemail message, said method being implemented by a proxy server, the method comprising:
   receiving, from a caller's user equipment, a call set-up request comprising information indicating a request by the caller to record a voice message directly on a voicemail server serving a callee;
   discriminating, in the received call set-up request, said information indicating a request for direct recording of a voice message; and
   responsive to discriminating, in the received call set-up request, said information indicating a request for direct recording of a voice message, setting up a communication session, between the caller's user equipment and said voicemail server serving the callee, to enable recording of said voice message.
2. The computer-implemented direct-voicemail recording method according to clause 1, wherein the call-set up request further comprises data identifying the callee, the method further comprising:
   discriminating, in the received call set-up request, said data identifying the callee; and
   responsive to discriminating, in the received call set-up request, said data identifying the callee, determining which voicemail server is said voicemail server serving the callee.
3. The computer-implemented direct-voicemail recording method according to clause 1 or 2, wherein:
   the proxy server is a Session Initiation Protocol server; and
   the call set-up request is an INVITE message according to the Session Initiation Protocol.
4. The computer-implemented direct-voicemail recording method according to clause 3, wherein:
   the discriminating, in the received call set-up request, of said information indicating a request for direct recording of a voice message comprises analysis of header fields in the received INVITE message according to the Session Initiation Protocol.
5. The computer-implemented direct-voicemail recording method according to clause 3, wherein the discriminating, in the received call set-up request, of said information indicating a request for direct recording of a voice message comprises detection, in the received INVITE message according to the Session Initiation Protocol, of a dedicated header field indicating whether or not direct recording of voice messages on said voicemail server is requested.
6. The computer-implemented direct-voicemail recording method according to any one of clause 3 to 5, wherein:
   responsive to the discriminating, in the received INVITE message according to the Session Initiation Protocol, of said information indicating a request for direct recording of a voice message, the SIP server retrieves callee status information; and
   there is further provided the step of discriminating direct-voicemail authorization data in the retrieved callee status information.
7. The computer-implemented direct-voicemail recording method according to clause 6, wherein:
   if the discriminating of direct-voicemail authorization data determines that the callee does not authorize direct recording of voice messages, the SIP server responds by generating a call set-up request and sending the call set-up request to the callee's user equipment, and
   if the discriminating of direct-voicemail authorization data determines that the callee authorizes direct recording of voicemails, the SIP server responds by determining which voicemail server is the voicemail server serving the callee and then setting up said communication session, between the caller's user equipment and said voicemail server serving the callee, to enable recording of said voicemail.
8. The computer-implemented direct-voicemail recording method according to clause 6, wherein:
   if the discriminating of direct-voicemail authorization data determines that the callee authorizes direct recording of voice messages conditionally dependent on the caller identity, the SIP server responds by determining the identity of the caller and:
      if the determined caller is not authorized by the callee to directly record voicemails, the SIP server generates a call set-up request and sends the call set-up request to the callee's user equipment, but
      if the determined caller is authorized by the callee to directly record voicemails, the SIP server determines which voicemail server is the voicemail server serving the callee and sets up said communication session, between the caller's user equipment and said voicemail server serving the callee, to enable recording of said voicemail.
9. A direct-voicemail system comprising:
   a caller's user equipment;
   a proxy server; and
   a voicemail server for recording voice messages for a callee;
   characterized in that:
   the caller's user equipment is configured to send the proxy server a call set-up request comprising information indicating a request by the caller to record a voice message directly on said voicemail server serving the callee; and
   the proxy server is configured to discriminate, in the received call set-up request, said information indicating a request for direct recording of a voicemail, and, responsive to discriminating said information indicating a request for direct recording of a voicemail:
      to determine which voicemail server is said voicemail server serving the callee; and
      to set up a communication session, between the caller's user equipment and said voicemail server serving the callee, to enable recording of said voicemail.
10. A proxy server configured to enable direct recording of voicemail messages, the proxy server comprising:
   a communications interface; and
   a processor;
   wherein the processor is configured:
      to discriminate, in a call set-up request received from a caller via the communications interface, information indicating a request for direct recording of a voice message; and
      responsive to discriminating said information indicating a request for direct recording of a voice message, to set up a communication session, between the caller's user equipment and a voicemail server serving the callee, to enable recording of said voicemail.
11. User equipment to enable direct recording of a voice message for a callee, the user equipment comprising a processing unit configured to:
   generate a call set-up request comprising information indicating a request to record a voice message directly on a voicemail server serving the callee; and
   send said call set-up request to a proxy server, in order to trigger the setup of a communication session, between the user equipment and a voicemail server serving the callee, to enable recording of said voice message.
12. User equipment according to clause 11, further comprising a dialler application configured to:
   present the caller with an input element enabling the caller to indicate a desire to record a voice message for a callee directly on a voicemail server serving said callee, and
   responsive to caller activation of said input element, trigger the generation by said processing unit of said call set-up request including information indicating a request to record a voice message directly on a voicemail serving the callee.
13. A computer-implemented method to enable direct recording of a voicemail message for a callee, the method being implemented by a caller's user equipment, the method comprising:
   generating a call set-up request including information indicating a request for direct recording of a voice message, and
   sending send call set-up request to a proxy server, in order to trigger the setup of a communication session, between the user equipment and a voicemail serve serving the callee, to enable recording of said voice message.
14. A computer program comprising instructions which, when the program is executed by a processing unit of a proxy server, cause said processing unit to perform a direct-voicemail recording method according to any one of clauses 1 to 8.
15. A computer program comprising instructions which, when the program is executed by a processing unit of a caller's user equipment, cause said processing unit to:
   generate a call set-up request including information indicating a request for direct recording of a voice message, and
   send said call set-up request to a proxy server, in order to trigger the setup of a communication session, between the user equipment and a voicemail server serving the callee, to enable recording of said voice message.

1. A computer-implemented method to directly record a voice message, said method being implemented by a proxy server, the method comprising:
receiving, from a user equipment of a caller, a call set-up request comprising information indicating a request by the caller to record a voice message directly on a voicemail server serving a callee;
discriminating, in the received call set-up request, said information indicating a request for direct recording of a voice message; and
responsive to said discriminating, in the received call set-up request, said information indicating a request for direct recording of a voice message, retrieving callee status information;
discriminating direct-voicemail authorization data in the retrieved callee status information;
responsive to said discriminating direct-voicemail authorization data in the retrieved callee status information, setting up a communication session between the user equipment of the caller and said voicemail server serving the callee, to enable recording of said voice message.

2. The method of claim 1, further comprising:
if the discriminating of direct-voicemail authorization data determines that the callee does not authorize direct recording of voice messages, generating a call set-up request and sending the call set-up request to the callee's user equipment; and
if the discriminating of direct-voicemail authorization data determines that the callee authorizes direct recording of voice messages, determining the voicemail server serving the callee and setting up said communication session, between the user equipment and said voicemail server (14) serving the callee, to enable recording of said voice message.

3. The method of claim 1, further comprising:
if the discriminating of direct-voicemail authorization data determines that the callee authorizes direct recording of voice messages conditionally dependent on the caller identity, determining the identity of the caller and:
if the determined caller is not authorized by the callee to directly record voicemails, generating a call set-up request and sending the call set-up request to the user equipment of the callee;
if the determined caller is authorized by the callee to directly record voicemails, determining the voicemail server serving the callee and setting up said communication session, between the user equipment of the caller and said voicemail server serving the callee, to enable recording of said voice message.

4. The method of claim 1, wherein the call-set up request further comprises data identifying the callee, the method further comprising:
discriminating, in the received call set-up request, said data identifying the callee; and
responsive to discriminating, in the received call set-up request, said data identifying the callee, determining said voicemail server serving the callee.

5. The method of claim 1, wherein:
the proxy server is a Session Initiation Protocol server; and
the call set-up request is an INVITE message according to the Session Initiation Protocol.

6. The method of claim 5, wherein the discriminating, in the received call set-up request, of said information indicating a request for direct recording of a voice message comprises analysis of header fields in the received INVITE message according to the Session Initiation Protocol.

7. The method of claim 5, wherein the discriminating, in the received call set-up request, of said information indicating a request for direct recording of a voice message comprises detection, in the received INVITE message according to the Session Initiation Protocol, of a dedicated header field indicating whether or not direct recording of voice messages on said voicemail server is requested.

8. (canceled)

9. A proxy server configured to enable direct recording of voicemail messages, the proxy server comprising:
a communications interface; and
a processor, wherein the processor is configured:
to discriminate, in a call set-up request received from a caller via the communications interface, information indicating a request for direct recording of a voice message; and
responsive to discriminating said information indicating a request for direct recording of a voice message, to retrieve callee status information;
to discriminate direct-voicemail authorization data in the retrieved callee status information; and
responsive to discriminating direct-voicemail authorization data in the retrieved callee status information, to set up a communication session, between a user equipment of the caller and a voicemail server serving the callee, to enable recording of said voice message.

10. The proxy server of claim 9, wherein said proxy server is further configured, responsive to discriminating direct-voicemail authorization data in the retrieved callee status information, to determine the voicemail server serving the callee.

11. User equipment to enable direct recording of a voice message for a callee, the user equipment comprising a processing unit configured to:
generate a call set-up request comprising information indicating a request to record a voice message directly on a voicemail server serving the callee; and
send said call set-up request to a proxy server in order to trigger, depending on direct-voicemail authorization data discriminated within callee status information retrieved by said proxy server, the setup of a communication session between the user equipment and a voicemail server serving the callee, to enable recording of said voice message.

12. The user equipment claim 11, further comprising a dialler application configured to:
present the caller with an input element enabling the caller to indicate a desire to record a voice message for a callee directly on a voicemail server serving said callee, and
responsive to caller activation of said input element, trigger the generation by said processing unit of said call set-up request including information indicating a request to record a voice message directly on a voicemail server serving the callee.

13. (canceled)

14. (canceled)

15. (canceled)
